(19) United States
(12) Patent Application Publication
(10) Pub. No.: US 2008/0153734 A1
(43) Pub. Date: Jun. 26, 2008

(54) METAL SURFACE CLEANER AND METHOD FOR CLEANING METAL PARTS

(75) Inventors: JIANG-RONG DING, Shenzhen (CN); ZHENG-JIANG REN, Shenzhen (CN); HONG-HAI XU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/847,290

(22) Filed: Aug. 29, 2007

(30) Foreign Application Priority Data
Dec. 22, 2006 (CN) 200610157859.9

(51) Int. Cl. C11D 3/04

(52) U.S. Cl. 510/245

(57) ABSTRACT

A surface cleaner for metal parts (e.g., steel articles) is an aqueous solution, which contains a component of phosphoric acid (H₃PO₄) from approximately 15 wt % (percent by weight) to approximately 25 wt %, a measurable component of ferrous ions (Fe²⁺) less than about 5 wt %, and water. Due to the beneficial composition of the surface cleaner, contaminants (e.g., oils, lubrications, and rust) can easily be removed from the surfaces of the metal parts, especially steel parts.

### BACKGROUND OF THE INVENTION

1. Field of the Invention

The present invention relates to surface cleaners and, particularly, to a surface cleaner for metal parts.

2. Description of Related Art

Generally, metal parts which are used in mobile devices, such as mobile phones, personal digital assistants, and mobile music players, are manufactured in the manner of a stamping process. During the stamping process, the metal parts may be inadvertently stained by any of various contaminants, e.g. lubricants, oils, and rust, which can be introduced by stamping punches and/or stamping molds. Thus, after the stamping process, the metal parts usually need to be treated in a surface-cleaning step, so as to remove the potential contaminants. The surface-cleaning step is typically carried out in an alkaline degreasing solution. However, during the surface-cleaning step in the alkaline degreasing solution, some yellow spots are often formed on the surface of the metal articles. The yellow spots may deteriorate decorative appearance of the metal parts.

Therefore, an improved metal surface cleaner is desired in order to overcome the above-described shortcomings.

### SUMMARY OF THE INVENTION

In one embodiment thereof, a surface cleaner for metal parts includes a component of phosphoric acid, in an approximate range from 15 wt % to 25 wt %, a ferrous component as a source of ferrous ions, and water. The ferrous ions are included in a positive, measurable amount less than about 5 wt %.

In another embodiment thereof, a method for cleaning surfaces of metal parts includes the following steps. In a first step, a surface cleaner, which contains a component of phosphoric acid composition, in an approximate range from approximately 15 wt % to 25 wt %, and water, is provided. In a second step, the metal parts are immersed into the surface cleaner, so as to clean the surfaces of the metal parts. In a last step, the metal parts are rinsed and dried.

Other advantages and novel features will become more apparent from the following detailed description of the present embodiments. No drawings are presented, as none are needed in order to understand the present cleaning system and method of using such.

### DETAILED DESCRIPTION OF THE INVENTION

In one present embodiment, a surface cleaner for metal parts (e.g., steel articles) is an aqueous solution, which contains a component of phosphoric acid (H₃PO₄) in an approximate range from 15 wt % (percent by weight) to 25 wt %, and water. The component of phosphoric acid (H₃PO₄) is advantageously about 20 wt %. The component of phosphoric acid may be beneficial to remove rust and/or other oxides from the metal parts without passivating surfaces of the metal parts. The surface cleaner may further contains a component acting as a source of ferrous ions (Fe²⁺). The amount of the ferrous ions should, beneficially, be less than about 5 wt % yet be a positive, measurable amount (i.e., above 0 wt %).

In a present embodiment, a method for cleaning surfaces of metal parts by use of the surface cleaner includes the following steps.

Firstly, a holding fixture (not shown) is provided. A plurality of metal parts is placed onto the holding fixture.

Secondly, a cleaning tank is provided. The cleaning tank has an ultrasonic generator and a heating device is mounted therein. The ultrasonic generator is used for applying ultrasonic vibrations to an aqueous cleaning agent (i.e., the surface cleaner) received in the cleaning tank. The heating device serves to maintain a temperature of the aqueous cleaning agent at a predetermined level.

Thirdly, the surface cleaner is prepared in the cleaning tank. A method of preparing the surface cleaner includes the following steps. Firstly, water is poured into the cleaning tank. Secondly, an appropriate amount of phosphoric acid (H₃PO₄) is added into the cleaning tank so as to obtain a phosphoric acid (H₃PO₄) solution from about 15 wt % (percent by weight) to about 25 wt %. The solution prepared in the cleaning tank may further contain a component acting as a source of ferrous ions (Fe²⁺). The amount of the ferrous ions should, beneficially, be less than about 5 wt % yet be a positive, measurable amount (i.e., above 0 wt %). Finally, the heating device is actuated to heat the solution prepared in the cleaning tank and maintain the temperature thereof within a range from approximately 50° C. to approximately 60° C. As such, the surface cleaner is prepared.

Fourthly, the metal parts to be cleaned, along with the holding fixture, are immersed into the surface cleaner in the cleaning tank. The ultrasonic generator is actuated to induce ultrasonic vibrations to the surface cleaner, which may favorably be used to facilitate degreasing and/or removal of oil stains. The metal parts are treated in the surface cleaner approximately for 5 minutes to 7 minutes. Oils and/or lubricants absorbed on the surfaces of the metal parts are thereby degreased by the surface cleaner during such treatment. Rust and/or other oxides can also be removed by the reaction with the phosphoric acid composition.

Fifthly, the metal parts are rinsed in running water, so as to remove the remained phosphoric acid composition from the surfaces thereof. The rinsing process may, usefully, be carried out for approximately 10 seconds, but it is to be understood that other rinsing times could be employed.

Finally, the metal parts are further rinsed in an aqueous auto-cleaning machine and dried in a drying machine, neither of which is shown.

A main advantage is that, due to the beneficial composition of the surface cleaner, contaminants (e.g., oils, lubrications, and rust) can easily be removed from the surfaces of the metal parts, especially from steel parts.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A surface cleaner for metal parts, comprising:
a component of phosphoric acid in an approximate amount from 15 wt % to 25 wt %;
a ferrous component as a source of ferrous ions, the ferrous ions being included in a positive, measurable amount less than about 5 wt %; and
water.

2. The surface cleaner as claimed in claim 1, wherein the component of phosphoric acid is about 20 wt %.

3. The surface cleaner as claimed in claim 1, wherein the surface cleaner is capable of cleaning surfaces of steel parts.

4. A method for cleaning surfaces of at least one metal part, comprising the steps of:
providing a surface cleaner containing a component of phosphoric acid, in an approximate amount from 15 wt % to 25 wt %, and water;
immersing the at least one metal part into the surface cleaner so as to clean the surfaces of the at least one metal part; and
rinsing and drying the at least one metal part.

5. The method as claimed in claim 4, wherein the surface cleaner is subjected to ultrasonic vibrations and heating.

6. The method as claimed in claim 4, wherein an amount of the component of phosphoric acid is about 20 wt %.

7. The method as claimed in claim 4, wherein the surface cleaner further includes a positive, measurable component of ferrous ions of less than about 5 wt %.

8. The method as claimed in claim 4, wherein a temperature of the surface cleaner is maintained in an approximate range from 50° C. to 60° C. during cleaning of the at least one metal part.
